(19) United States
(12) Patent Application Publication
(10) Pub. No.: US 2024/0192423 A1
(43) Pub. Date: Jun. 13, 2024

(54) IMAGE DISPLAY DEVICE AND IMAGE DISPLAY METHOD

(71) Applicant: SONY GROUP CORPORATION, TOKYO (JP)

(72) Inventor: KAZUE SHIMIZU, TOKYO (JP)

(21) Appl. No.: 18/256,046

(22) PCT Filed: Nov. 17, 2021
(86) PCT No.: PCT/JP2021/042179

§ 371 Date: Jan. 15, 2024

(30) Foreign Application Priority Data
Dec. 11, 2020 (JP) 2020-205589

(51) Int. Cl. F21V 8/00; G02B 5/32; G02B 27/01

(52) U.S. Cl. CPC G02B 6/0016; G02B 5/32; G02B 6/0036; G02B 27/0101; G02B 2027/0112; G02B 2027/0134; G02B 2027/0136

(57) ABSTRACT

There is provided an image display device capable of displaying more information by enlarging a display angle-of-view region while suppressing color unevenness with a simple configuration. An image display device 10 includes: an image forming unit 13 that has a plurality of pixels and emits image light from the plurality of pixels; an optical system 12 that converts each beam of the image light having an image height emitted from the image forming unit into a parallel beam having an angle of view; a light guide plate 11 on which the image light converted by the optical system is incident, in which the image light propagates, and from which the image light is emitted to the outside; a first diffraction grating 14 that is provided on the light guide plate, diffracts and reflects the image light incident on the light guide plate, and propagates the image light inside the light guide plate; and a second diffraction grating 15 that is provided on the light guide plate, diffracts and reflects the image light that has propagated inside the light guide plate, and emits the image light from the light guide plate to the outside. The image forming unit 13 divides the image light into a plurality of color beams.

### TECHNICAL FIELD

The present technology relates to an image display device and an image display method, and more particularly to an image display device and an image display method that display an image by using a light guide plate having a diffraction grating.

### BACKGROUND ART

Conventionally, there has been known an image display device (eyewear) using a hologram diffraction grating for providing a color image to an observer and to a user with a two-dimensional image formed by an image forming unit as an enlarged virtual image by a virtual image optical system.

For example, Patent Document 1 proposes an image display device including an image forming device, a collimating optical system, and an optical device, in which the optical device includes a light guide plate, and a first diffraction grating member and a second diffraction grating member each including a reflective volume hologram diffraction grating, the first diffraction grating member and the second diffraction grating member include the same material, and the thickness of the second diffraction grating member is thinner than the thickness of the first diffraction grating member 30.

Furthermore, Patent Document 2 discloses an optical device in which a plurality of light guide plates each configured such that parallel light flux groups having different traveling orientations from each other are incident thereon, propagate therein by total reflection, and then exit is laminated via a medium having a refractive index lower than that of the light guide plate, in which each of the plurality of light guide plates includes a first reflective volume holographic grating that diffracts and reflects the parallel light flux groups so as to satisfy an internal total reflection condition in the light guide plate while keeping the parallel light flux groups as the parallel light flux groups in an incident region of the parallel light flux groups, and a second reflective volume holographic grating that diffracts and reflects the parallel light flux groups in an emission region of the parallel light flux group such that the parallel light flux groups exit the light guide plate while keeping the parallel light flux groups as the parallel light flux groups, and the parallel light flux groups that have different traveling orientations, propagate while repeating total reflection from the incident region to the exit region in the plurality of light guide plates at least partially have different number of total reflections due to the difference in traveling orientation.

Furthermore, Patent Document 3 proposes a display system for an augmented reality display including a waveguide which is a prism having a plurality of surfaces, a first input projector that is arranged to project light on the waveguide via a first surface, a second input projector that is arranged to project light on the waveguide via a second surface, at least one input grating that couples light from the first input projector and the second input projector into the waveguide, and at least one output grating that couples light from the waveguide toward a viewer/listener.

### CITATION LIST

### Patent Document

Patent Document 1: Japanese Patent Application Laid-Open No. 2012-159856
Patent Document 2: Japanese Patent Application Laid-Open No. 2007-011057
Patent Document 3: U.S. unexamined Patent Application Publication No. 2018/0003994

### SUMMARY OF THE INVENTION

### Problems to be Solved by the Invention

Here, the technology of Patent Document 1 is based on the premise that, in coloring, volume holograms each having a slant angle and a pitch satisfying a Bragg condition for each color are laminated and used or the volume hologram is used in multiple exposure. Furthermore, the technology of Patent Document 1 aims to expand the angle of view while suppressing color unevenness by utilizing the fact that the Bragg condition shifts in wavelength according to the incident angle. However, in the technology of Patent Document 1, in a case where coloring is realized with one light guide plate, a diffraction grating with pitches different for each color are required, and there is a problem that it is difficult to avoid a ghost due to occurrence of crosstalk of different colors diffracted at the same light guide angle by the diffraction grating. Moreover, in the technology of Patent Document 1, the incident angle center is tilted to the output side, but in the case of considering that RGB are diffracted by the same diffraction grating, the angle of view decreases, which is a disadvantageous structure.

Furthermore, in the technology of Patent Document 2, in order to avoid crosstalk, the number of light guide plates is increased in coloring, and wavelengths at which crosstalk occurs are separately guided. In addition, the technology of Patent Document 2 is based on the premise that diffraction is performed by using a volume type hologram having a high wavelength selection control of diffraction and that a diffraction grating having pitches different for each of RGB are used. However, in the technology of Patent Document 2, the number of light guide plates increases in addition to arranging a plurality of diffraction gratings. Therefore, there is a problem that it is technically difficult to match images of two plates, and the cost increases at the time of mass production.

Furthermore, the technology of Patent Document 3 is a technology that aims to increase the angle of view with respect to the direction perpendicular to the light guide direction when viewed from the wider surface side of the light guide plate, and can more densely arrange light sources by arranging the light sources on the front and back surfaces to suppress unevenness. However, in the technology of Patent Document 3, it is necessary to arrange two or more light sources on the front and back, and there is a problem that it is technically difficult to match the positions of the images of the plurality of light sources and the cost increases at the time of mass production. Moreover, in the technology of Patent Document 3, although there is a description “tilted at 20 degrees to the opposite side from the output side for coloring” in Examples, there is no specific description, and the angle of view enlargement in the light guide direction is insufficient.

Therefore, a main object of the present technology is to provide an image display device capable of displaying more information by enlarging a display angle-of-view region while suppressing color unevenness with a simple configuration.

### Solution to Problems

The present technology provides an image display device including: an image forming unit which has a plurality of pixels and emits image light from the plurality of pixels; an optical system which converts each beam of the image light having an image height emitted from the image forming unit into a parallel beam having an angle of view; a light guide plate on which the image light converted by the optical system is incident, in which the image light propagates, and from which the image light is emitted to the outside; a first diffraction grating which is provided on the light guide plate, diffracts and reflects the image light incident on the light guide plate, and propagates the image light inside the light guide plate; and a second diffraction grating which is provided on the light guide plate, diffracts and reflects the image light that has propagated inside the light guide plate, and emits the image light from the light guide plate to the outside, in which the image forming unit divides the image light into a plurality of color beams.

Furthermore, the present technology provides an image display method including: a step of including a plurality of pixels and emitting image light divided into a plurality of color beams from the plurality of pixels; a step of causing the image light that has been emitted to be incident on a light guide plate; a step of diffracting and reflecting the image light incident on the light guide plate and propagating the image light inside the light guide plate; and a step of diffracting and reflecting the image light that has propagated inside the light guide plate and emitting the image light from the light guide plate to the outside.

### Effects of the Invention

According to the present technology, an image display device capable of displaying more information by enlarging a display angle-of-view region while suppressing color unevenness with a simple configuration can be provided. Note that the effects described above are not necessarily limited, and along with or in lieu of the effects described above, any of the effects described in the present Description, or another effect that can be grasped from the present Description may be exhibited.

### BRIEF DESCRIPTION OF DRAWINGS

FIG. 1 is a schematic configuration view of an image display device according to a first embodiment of the present technology as viewed from above.

FIG. 2 is a schematic view of an example of a display image displayed by using the image display device according to the first embodiment of the present technology.

FIG. 3 is a schematic view illustrating an angle-of-view region that can be expressed by RGB wavelengths by using the image display device according to the first embodiment of the present technology.

FIG. 4 is a schematic view illustrating an angle-of-view region that can be expressed by RGB wavelengths by using the image display device according to the first embodiment of the present technology.

FIG. 5 is a graph of diffraction efficiency at each of RGB wavelengths that can be expressed by using an image display device according to a second embodiment of the present technology.

FIG. 6 is a schematic view illustrating shape examples of an incident-side diffraction grating of the image display device according to the second embodiment of the present technology.

FIG. 7 is a schematic view of use examples in which a diffraction grating of the image display device according to the second embodiment of the present technology is a reflective diffraction grating or a transmissive diffraction grating.

FIG. 8 is a schematic view illustrating examples of a structure for suppressing unnecessary light of an emission-side diffraction grating of an image display device according to a third embodiment of the present technology.

FIG. 9 is a graph illustrating an example of diffraction efficiency of necessary light with unnecessary light suppressed by using the image display device according to the third embodiment of the present technology.

FIG. 10 is a schematic diagram illustrating a use example (an example of light-emitting pixels for regions) of a self-luminous panel of an image display device according to a fourth embodiment of the present technology.

FIG. 11 is a schematic view illustrating a use example in the self-luminous panel of the image display device according to the fourth embodiment of the present technology (in a case where each of all the monochromatic panels can be used in a same color).

FIG. 12 is a schematic view illustrating examples of a transmissive color filter to be inserted into the image display device according to the fourth embodiment of the present technology.

FIG. 13 is a diagram illustrating an example of removing background noise by adding a color filter to the image display device according to the fourth embodiment of the present technology.

FIG. 14 are graphs illustrating variations in average wavelength in a case where the image display device according to the fourth embodiment of the present technology includes a band-pass filter.

FIG. 15 is a schematic view illustrating an installation example of diffraction gratings in an image display device according to a fifth embodiment of the present technology.

FIG. 16 is a schematic view illustrating an example of display divided by color, the display being displayed by using the image display device according to the fifth embodiment of the present technology.

FIG. 17 is a schematic view illustrating an installation example of diffraction gratings in an image display device according to a sixth embodiment of the present technology.

FIG. 18 is a schematic view illustrating an example of display divided by color, the display being displayed by using the image display device according to the sixth embodiment of the present technology.

FIG. 19 is a schematic view illustrating an installation example of diffraction gratings in an image display device according to a seventh embodiment of the present technology.

FIG. 20 is a schematic view illustrating an example of display divided by color, the display being displayed by using the image display device according to the seventh embodiment of the present technology.

FIG. 21 is a schematic view illustrating a relationship between an incident angle and selectable colors by the image display device according to an eighth embodiment of the present technology.

FIG. 22 is a schematic view illustrating an arrangement example of image display devices according to a ninth embodiment of the present technology.

FIG. 23 is a schematic view illustrating an arrangement example of image display devices according to a tenth embodiment of the present technology.

FIG. 24 is a schematic view illustrating an arrangement example of an image display device according to an eleventh embodiment of the present technology.

### MODE FOR CARRYING OUT THE INVENTION

Hereinafter, preferred embodiments of the present technology will be described with reference to the drawings. The embodiments described below illustrate examples of a representative embodiment of the present technology, and any embodiment can be combined with any other embodiment. Furthermore, the scope of the present technology is not narrowly interpreted by the embodiments. Note that the description will be given in the following order.
1. First Embodiment
(1) Configuration Example of Image Display Device
(2) Example of Display Image
(3) Example of Image Display Method
2. Second Embodiment
3. Third Embodiment
4. Fourth Embodiment
5. Fifth Embodiment
6. Sixth Embodiment
7. Seventh Embodiment
8. Eighth Embodiment
9. Ninth Embodiment
10. Tenth Embodiment
11. Eleventh Embodiment

### 1. First Embodiment

### (1) Configuration Example of Image Display Device

First, a configuration example of an image display device according to a first embodiment of the present technology will be described with reference to FIG. 1. FIG. 1 is a schematic configuration view of an image display device 10 according to the present embodiment as viewed from above.

The image display device 10 can be used as, for example, a holographic wavefront reconstruction eyewear display that applies light to a hologram and creates the same wavefront as that of object light that is an original signal wave by using diffraction by interference fringes recorded in the hologram. In particular, the image display device 10 can be applied to an optical system that realizes angle-of-view display divided by color for augmented reality (AR).

As illustrated in FIG. 1, the image display device 10 includes, as an example, a light guide plate 11, a projection lens 12 that is an optical system, an image forming unit 13 having light-emitting light sources with two or more wavelengths, an incident-side diffraction grating 14 as a first diffraction grating, and an emission-side diffraction grating 15 as a second diffraction grating.

The light guide plate 11 is a parallel flat plate for guiding light beams from each light source without changing each light guide angle. Image light condensed by the projection lens 12 is incident on the light guide plate 11, and the incident image light propagates inside the light guide plate 11 and is emitted to the outside.

The projection lens 12 is arranged between the image forming unit 13 and the light guide plate 11, and condenses light emitted from a plurality of pixels of the image forming unit 13. Furthermore, the projection lens 12 can convert each beam of the image light having an image height emitted from the image forming unit 13 into a parallel beam having an angle of view. The projection lens 12 can also be arranged to be inclined with respect to the light guide plate 11 or the image forming unit 13.

The image forming unit 13 includes a plurality of pixels arranged to face one end of the light guide plate 11 and disposed in a two-dimensional matrix, and emits image light from these pixels. Furthermore, the image forming unit 13 has a region divided by color that divides the image light into a plurality of color beams. The ear-side angle of view on the incident side of the image forming unit 13 is a short wavelength display range, and the nose-side angle of view on the emission side of the image forming unit 13 is a long wavelength display range. Note that a color filter may be provided in the image forming unit 13.

The light source of the image forming unit 13 may be a liquid crystal on silicon (LCOS) system or a high temperature poly-silicon (HTPS) system including a display unit that creates a video or an image and including an illumination system even in the case of a self-luminous light source, or may be a digital light processing (DLP) system. The light source in the case of a self-luminous light source may be a light emitting diode (LED) light source which is integrated with a panel and is an extended source, or a laser diode (LD) light source.

The incident-side diffraction grating 14 is, for example, a reflective diffraction grating, and is provided at one end of a surface of the light guide plate 11 opposite to the incident surface side where the image forming unit 13 is arranged. The incident-side diffraction grating 14 is a diffraction grating for bending image light from the outside of the light guide plate 11 in a light guide angle direction, and diffracts and reflects the image light incident on the light guide plate 11 to propagate the image light inside the light guide plate 11.

The emission-side diffraction grating 15 is, for example, a reflective diffraction grating, and is provided at the other end on the same surface of the light guide plate 11 as the surface where the incident-side diffraction grating 14 is provided. The emission-side diffraction grating 15 is a diffraction grating for emitting the guided image light to the outside of the light guide plate 11, and diffracts and reflects the image light that has propagated inside the light guide plate 11 and emits the image light to the outside of the light guide plate 11. The emission-side diffraction grating 15 has the same pitch of the diffraction grating as that of the incident-side diffraction grating 14, and has a function of closing a grating vector. Furthermore, the emission-side diffraction grating 15 may have a function of spreading light. Note that the incident-side diffraction grating 14 and the emission-side diffraction grating 15 may be of a volume type or a surface-relief type.

The user observes an image displayed by image light diffracted and reflected by the emission-side diffraction grating 15 and emitted to the outside of the light guide plate 11 with an eyeball 16 from the side where the image forming unit 13 is arranged.

The image display device 10 illustrated in FIG. 1 illustrates a configuration in a case where three colors of red, green, and blue (RGB) are used as light-source wavelengths. The image display device 10 performs division by color in regions with respect to the image heights of the image forming unit 13 as a video source. Beams of image light in respective colors having image heights are converted into parallel beams having angles of view different from each other by the projection lens 12, and are further converted into angles in a light guide direction by the incident-side diffraction grating 14 of the light guide plate 11. An incident beam L1 and an incident beam L2 with different angles that have been guided are returned to the angles before entering the light guide plate 11 by the emission-side diffraction grating 15, enter the pupil of the eyeball 16, and can be viewed as an image.

### (2) Example of Display Image

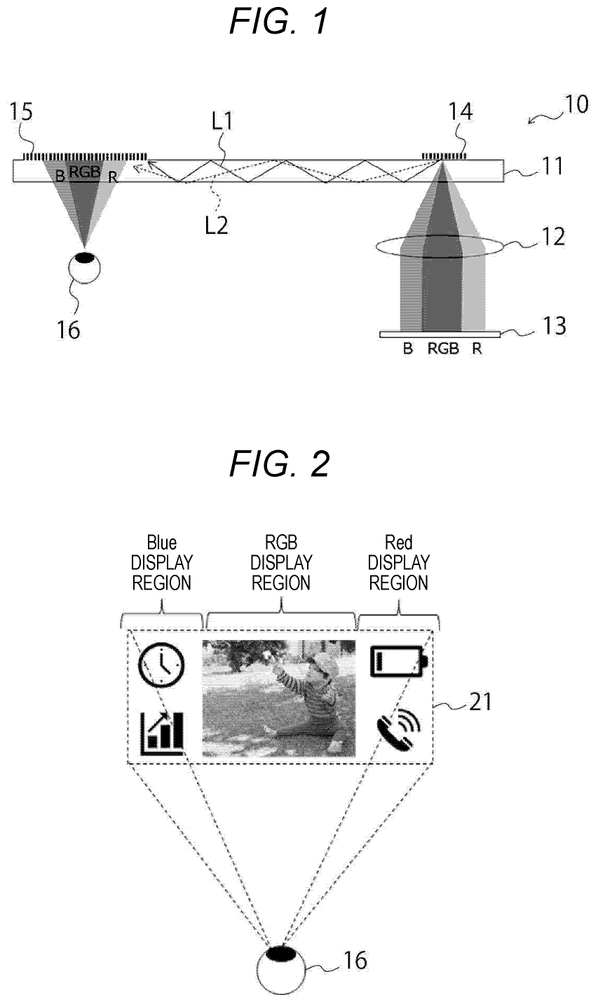

Next, an example of a display image by the image display device 10 will be described with reference to FIGS. 2 to 4. FIG. 2 is a schematic view of an example of a display image displayed by using the image display device 10 according to the present embodiment. The display image illustrated in FIG. 2 is an example of an image divided by color in an angle of view or an image height actually viewed by the user.

As illustrated in FIG. 2, an RGB display region expressed by an RGB light source at the center of the display image displays information that is desirably displayed in colors such as an image and a video. It is assumed that an icon, a character, or the like is displayed in portions expressed in a single color at ends of the angle of view, the portions being a blue display region on the left as one faces and a red display region on the right as one faces in the display image. Note that the relationship between the display region and the information to be displayed is not limited to the present embodiment, and information may be freely arranged.

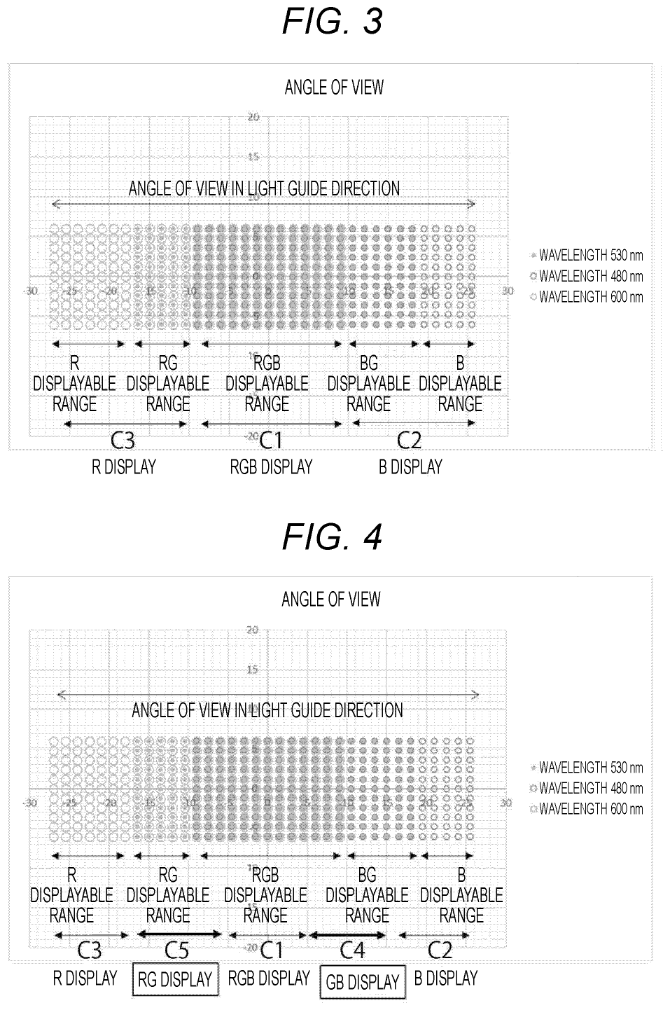

Next, an angle-of-view region that can be expressed by RGB wavelengths by using the image display device 10 will be described with reference to FIGS. 3 and 4. FIG. 3 is a schematic view illustrating an angle-of-view region that can be expressed by RGB wavelengths by using the image display device 10 according to the present embodiment. FIG. 4 is a schematic view illustrating another example of the angle-of-view region that can be expressed by RGB wavelengths by using the image display device 10 according to the present embodiment.

As an example, a case where there are two diffraction gratings, that is, the incident-side diffraction grating 14 and the emission-side diffraction grating 15 having equal pitches on the light guide plate 11 of the image display device 10 will be described. As an example, the refractive index of the light guide plate 11 is set to 1.7, and the light source wavelengths in the diffraction grating is set to three wavelengths of 480 nm, 530 nm, and 600 nm. Furthermore, the pitches of the incident-side diffraction grating 14 and the emission-side diffraction grating 15 are both 412 nm.

In this case, as illustrated in FIG. 3, the angles of view that can be taken at the respective wavelengths are a region C1 of RGB display at 530 nm, a region C2 of B display at 480 nm, and a region C3 of R display at 600 nm. Note that a region where all the three wavelengths overlap is an RGB displayable range, a region where the wavelengths of 530 nm and 480 nm overlap is a BG displayable range, a region where the wavelengths of 530 nm and 600 nm overlap is an RG displayable range, a region of only the wavelength of 480 nm is a B displayable range, and a region of only the wavelength of 600 nm is an R displayable range.

Here, in the conventional technology, since the region C2 and the region C3 are regions where color unevenness occurs due to wavelength dispersion (color dispersion) particularly in a light source having a spectrum width such as an LED light source, only the angle of view expressed by RGB of the region C1 is used. Therefore, in the image display device 10 of the present embodiment, the color is limited for each region by intentionally narrowing the wavelength on the image forming unit 13 side, and the angles of view of the region C2 and the region C3, which have been conventionally discarded, are used as specific single color display regions to enable information display at a wide angle of view.

In the present embodiment, display is performed while limiting the wavelength to the wavelength of blue in the region on the image forming unit 13 side corresponding to the region C2. Furthermore, display is performed while limiting the wavelength to the wavelength of red in the region on the image forming unit 13 side corresponding to the region C3. That is, the RGB color display region C1 performs display for an angle of view of 18 degrees in the light guide direction, the Blue monochrome display region C2 performs display for an angle of view of 16 degrees, and the Red monochrome display region C3 also performs display for an angle of view of 16 degrees. Then, the Blue display region C2 is provided on a side farther from the incident-side diffraction grating 14, and the Red display region C3 is provided on a side closer to the incident-side diffraction grating 14.

However, the display region in the present embodiment is not fixed to the region illustrated in FIG. 3, and the display region can be freely divided as long as a wavelength exists in each region. As illustrated in FIG. 4, as another example of the manner of dividing the display region, the RGB color display region C1 can be reduced, and in addition to the RGB region C1, the blue display region C2, and the red display region C3, a GB display region C4 for cyan display and an RG display region C5 for yellow display can be newly provided. Note that in the manners of dividing the display region illustrated in FIGS. 3 and 4, it is necessary to limit the wavelength of the corresponding display region.

### (3) Example of Image Display Method

Next, an example of the image display method using the image display device 10 according to the present embodiment will be described with reference to FIGS. 1 to 4.

First, in step S1, the user wears the image display device 10 such as eyewear. When the user wears the image display device 10, the power of the image display device 10 is turned on.

Next, in step S2, the image forming unit 13 having a plurality of pixels emits image light divided into a plurality of color beams from the plurality of pixels.

In step S3, each beam of the image light having an image height emitted from the pixel is converted into a substantially parallel beam having an angle of view by the projection lens 12 and is incident on the light guide plate 11.

In step S4, the incident-side diffraction grating 14 diffracts and reflects the image light incident on the light guide plate 11 and propagates the image light inside the light guide plate 11.

In step S5, the emission-side diffraction grating 15 diffracts and reflects the image light propagated inside the light guide plate 11 and emits the image light from the light guide plate 11 to the outside.

In step S6, the pupil of the eyeball 16 of the user is irradiated with the image light emitted to the outside. Then, the user views/listens the color display image or video divided by color and displayed on the image display device 10.

In the image display device 10 according to the present embodiment, the incident-side diffraction grating 14 and the emission-side diffraction grating 15 are provided on one light guide plate 11, and light guide angles (diffraction angles) are different for RGB. Furthermore, since the image display device 10 has a large diffraction efficiency in all of the RGB use wavelengths and use angles of the respective diffraction gratings, it is sufficient if only one light guide plate 11 is provided without providing a plurality of light guide plates. Furthermore, the image display device 10 has a structure in which the angle-of-view region that has been discarded in the related art is displayed in a specific color according to the angle of view (with respect to the image height) by the image forming unit 13 and is divided by color. Therefore, according to the image display device 10, there is no concern of crosstalk, and the cost can be reduced. Note that the image display device 10 can also increase the degree of freedom in setting of division by RGB colors by inclining the incident angle of the incident image light in the direction opposite to the emission side.

Moreover, the image display device 10 has an angle-of-view enlargement structure in which the angle-of-view display region other than overlap of the set RGB wavelengths is monochromatic light emission, color unevenness is suppressed, and monochromatic regions are used. Therefore, in the image display device 10, division by color is performed by the image forming unit 13 on the video source side, and a region where color unevenness occurs due to wavelength dispersion is used as a monochromatic region to enlarge the display region.

As described above, according to the image display device 10 such as eyewear, since screen display divided by color is realized by using the light guide plate 11 on which the incident-side diffraction grating 14 and the emission-side diffraction grating 15 are provided, it is possible to display more information by enlarging the display angle-of-view region while suppressing color unevenness with a simple configuration.

### 2. Second Embodiment

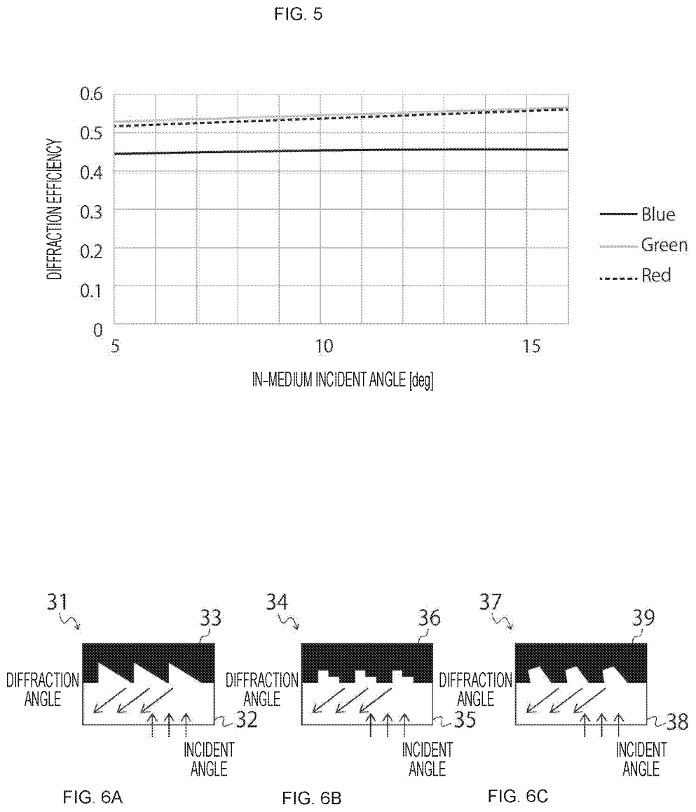

Next, a configuration example of a diffraction grating of an image display device according to a second embodiment of the present technology will be described with reference to FIGS. 5 to 7. FIG. 5 is a graph illustrating diffraction efficiency at each of RGB wavelengths that can be expressed by using the image display device according to the present embodiment. In FIG. 5, the horizontal axis represents the in-medium incident angle, and the vertical axis represents the diffraction efficiency. FIG. 6 is a schematic view illustrating shape examples of an incident-side diffraction grating of the image display device according to the present embodiment.

The diffraction grating used in the image display device according to the present embodiment does not prepare an optimal pitch for each of the set wavelengths of RGB or the like, but diffracts all wavelengths the at one pitch. Therefore, diffraction efficiency is required for the wavelengths and the angle of view to be used. In the present embodiment, a surface-relief type diffraction grating is used, and as an example, the diffraction grating has a refractive index of 1.58 and a pitch of 490 nm. As illustrated in FIG. 5, in the present embodiment, the diffraction efficiency at the wavelength of B is designed to be slightly lower than the wavelengths of RG, but these wavelengths can be arbitrarily designed by changing the shape of the diffraction grating according to the efficiency of the light source to be used. Furthermore, as another example, the refractive index of the diffraction grating may be 1.64 and the pitch may be 580 nm. In this case, in the range of the in-medium incident angle to be used, it is possible to design a shape in which all the wavelengths of RGB have the same degree of diffraction efficiency in one diffraction grating.

FIG. 6A illustrates a blazed incident-side diffraction grating 31. FIG. 6B illustrates a stepped incident-side diffraction grating 34. FIG. 6C illustrates an overhanging blazed incident-side diffraction grating 37. In the incident-side diffraction grating 31, the incident-side diffraction grating 34, and the incident-side diffraction grating 37, surfaces of diffraction gratings 32, 35, and 38 are covered with aluminum, silver, or other highly reflective metal films 33, 36, and 39, respectively. The surfaces of the incident-side diffraction grating 31, the incident-side diffraction grating 34, and the incident-side diffraction grating 37 are coated with the highly reflective metal films 33, 36, and 39, respectively to increase the reflectance. It is sufficient if the coating by each of the highly reflective metal films 33, 36, and 39 is at least about 50 nm. Note that, if the power of the light source of an image forming unit 13 has a margin, a simple binary diffraction grating may be used instead of a blazed incident-side diffraction grating and a stepped incident-side diffraction grating, and the incident-side diffraction grating 31, the incident-side diffraction grating 34, and the incident-side diffraction grating 37 may not be covered with a metal film.

In the present embodiment, a surface-relief type diffraction grating is used, but a volume type hologram diffraction grating can also be used as long as diffraction efficiency in the used angle-of-view range and wavelength range of the present embodiment can be provided. Furthermore, in the present embodiment, a reflective diffraction grating is used, but a transmissive diffraction grating can also be used.

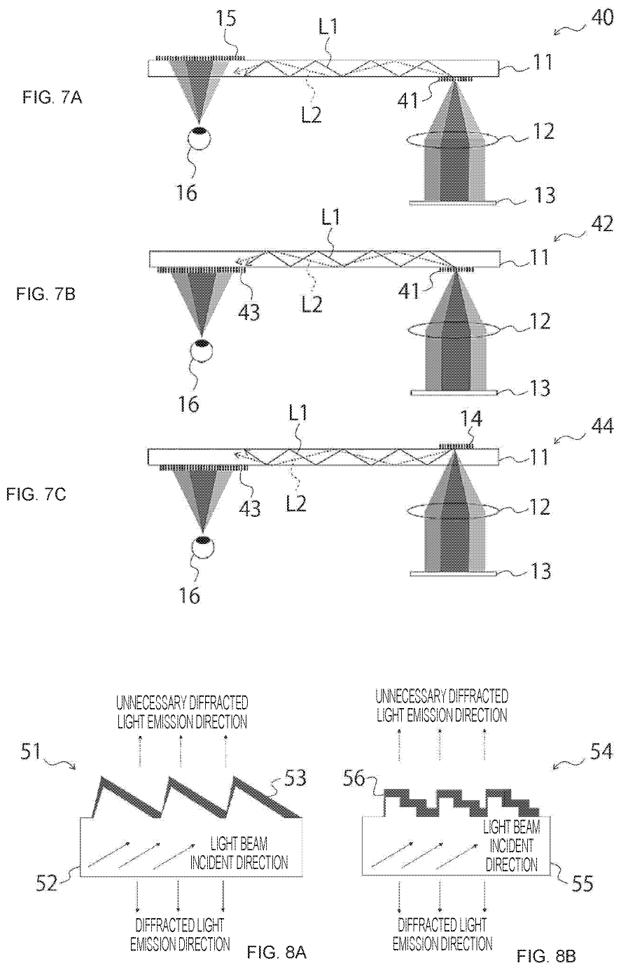

FIG. 7 is a schematic view of use examples in which a diffraction grating of the image display device according to the present embodiment is a reflective diffraction grating or a transmissive diffraction grating. The configuration of the image display device illustrated in FIG. 7 other than the diffraction gratings is similar to the configuration of the image display device 10 according to the first embodiment.

An image display device 40 illustrated in FIG. 7A uses a transmissive incident-side diffraction grating 41 and a reflective emission-side diffraction grating 15. An image display device 42 illustrated in FIG. 7B uses a transmissive incident-side diffraction grating 41 and a transmissive emission-side diffraction grating 43. In FIG. 7C, a reflective incident-side diffraction grating 14 and a transmissive emission-side diffraction grating 43 are used. As illustrated in FIGS. 7A to 7C, in a case where the transmissive diffraction grating 41 or 43 is used, it is necessary to arrange the diffraction grating 41 or 43 on the image-light incident surface side of a light guide plate 11.

### 3. Third Embodiment

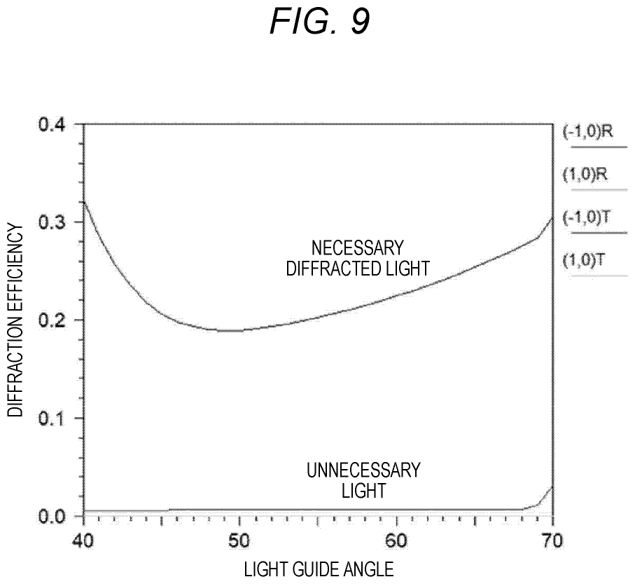

Next, a configuration example of a diffraction grating of an image display device according to a third embodiment of the present technology will be described with reference to FIGS. 8 and 9. FIG. 8 is a schematic view illustrating examples of a structure for suppressing unnecessary light of an emission-side diffraction grating of the image display device according to the present embodiment.

FIG. 8A illustrates a blazed emission-side diffraction grating 51. In the emission-side diffraction grating 51, the surface of a blazed diffraction grating 52 is covered with a high refractive material film 53 such as TiO₂. FIG. 6B illustrates a stepped emission-side diffraction grating 54. Also in the emission-side diffraction grating 54, the surface of a stepped diffraction grating 55 is covered with a high refractive material film 56 such as TiO₂.

Here, for example, in a case where a reflective diffraction grating is used on the emission side, the surface-relief type diffraction grating often has a certain degree of diffraction efficiency also in a direction of penetrating the diffraction grating. Diffraction in the direction of penetrating the diffraction grating becomes unnecessary light and causes efficiency loss. Furthermore, it is desirable that a large difference does not occur in the diffraction efficiency distribution in the used angle range. In particular, it is desirable that the diffraction efficiency is higher as the light guide angle with the incident or emission surface increases. Therefore, in the present embodiment, the diffraction grating shape is optimized.

In the emission-side diffraction grating 51 and the emission-side diffraction grating 54 of the image display device according to the present embodiment, for example, the high refractive material films 53 and 56 such as TiO₂ having a refractive index of 2 or more are applied with a thickness of several tens of nm to relatively increase the diffraction efficiency. As a result, the image display device according to the present embodiment can suppress transmitted diffracted light that becomes unnecessary diffracted light.

Note that, depending on the pitch, it is preferable to apply the high refractive material films 53 and 56 only on the slope sides of the surfaces of the emission-side diffraction grating 51 and the emission-side diffraction grating 54. In the present embodiment, an example at the time of P-polarization is illustrated, and the high refractive material films 53 and 56 of TiO₂ are applied with a thickness of 20 to 30 nm. However, the necessary thicknesses of the high refractive material films 53 and 56 change according to the refractive index of the base material, the high refractive index material to be applied, and polarization. Note that the higher the refractive index of the material, the wider the angle of view. Therefore, by using a material having a high refractive index, it is possible to expand the region where all the wavelengths of RGB can be used, and to increase the degree of freedom of division by color.

FIG. 9 is a graph illustrating an example in which necessary diffracted light has diffraction efficiency of about 20% and unnecessary light is suppressed by using the image display device according to the present embodiment. In FIG. 9, the horizontal axis represents the light guide angle, and the vertical axis represents the diffraction efficiency. As illustrated in FIG. 9, the image display device according to the present embodiment can suppress unnecessary light when the diffraction efficiency of the necessary diffracted light is set to about 20%.

### 4. Fourth Embodiment

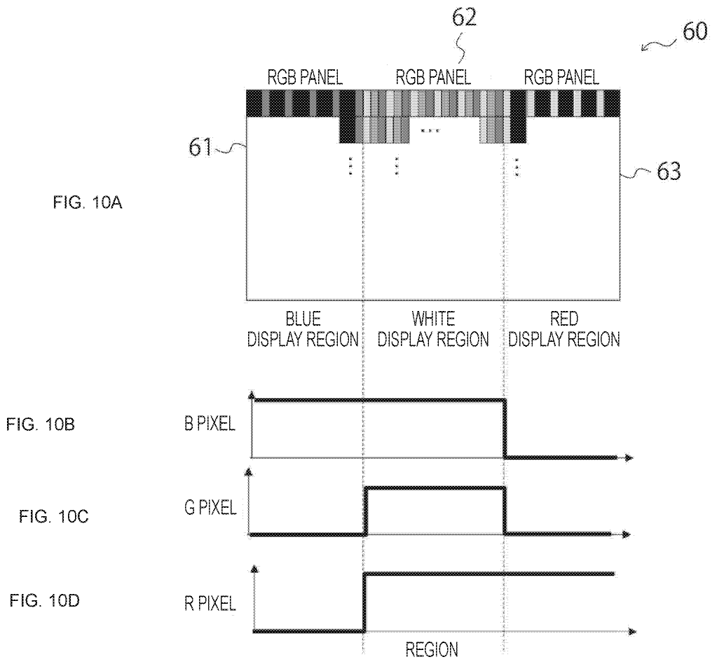

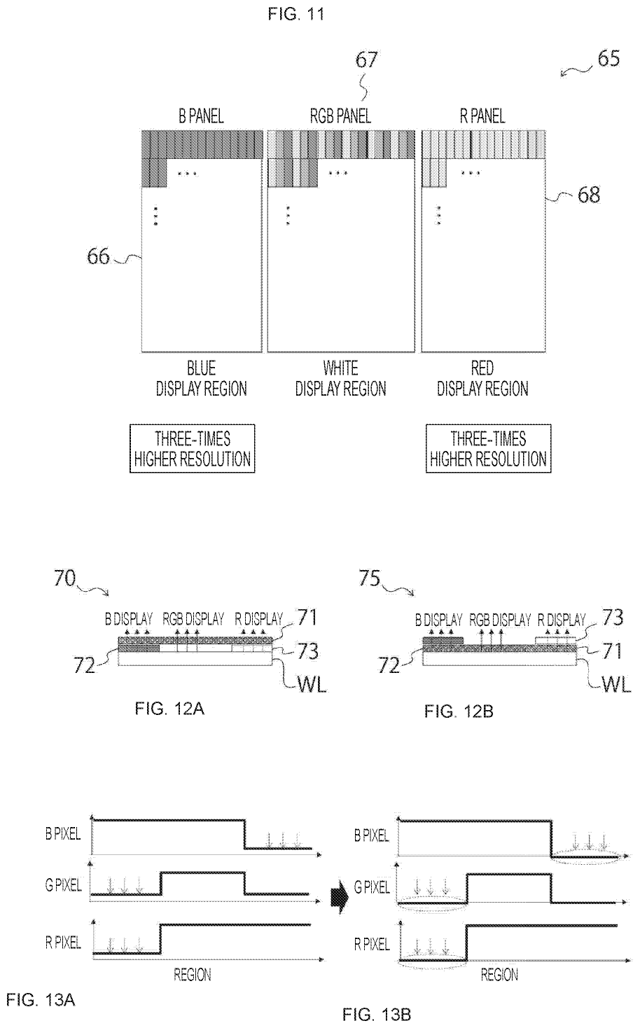

Next, an example of separating a video surface or an image surface by color by an image display device according to a fourth embodiment of the present technology will be described with reference to FIGS. 10 to 14. First, a case of using a self-luminous panel will be described with reference to FIGS. 10 and 11.

FIG. 10 is a schematic diagram illustrating a use example (an example of light-emitting pixels for regions) of a self-luminous panel 60 of an image display device according to the present embodiment. FIG. 10A illustrates an example of the self-luminous panel 60 in which one pixel has RGB. FIG. 10B illustrates a relationship between each display region of the self-luminous panel 60 and a blue (B) pixel, FIG. 10C illustrates a relationship between each display region of the self-luminous panel 60 and a green (G) pixel, and FIG. 10D illustrates a relationship between each display region of the self-luminous panel 60 and a red (R) pixel.

As illustrated in FIG. 10A, in the self-luminous panel 60, an RGB panel 61 of a blue (B) display region, an RGB panel 62 of a white display region, and an RGB panel 63 of a red (R) display region are arranged on a low wavelength side, a center, and a high wavelength side, respectively, correspondingly to the angles of view. Furthermore, as illustrated in FIG. 10B, the B pixel is higher in the B display region and the white display region. Furthermore, as illustrated in FIG. 10C, the G pixel is higher in the white display region. Then, as illustrated in FIG. 10D, the R pixel is higher in the white display region and the R display region.

As described above, the self-luminous panel 60 can be created by limiting light emission of each pixel of the display region corresponding to the angle of view. In the self-luminous panel 60, the white display region, the B display region, and the R display region have the same pixel pitch and the same resolution.

FIG. 11 is a schematic view illustrating a use example of a self-luminous panel 65 of the image display device according to the present embodiment (in a case where an entire monochromatic panel can be used in the same color). As illustrated in FIG. 11, in the self-luminous panel 65, a B panel 66 of a B display region, an RGB panel 67 of a white display region, and an R panel 68 of an R display region are arranged on a low wavelength side, a center, and a high wavelength side, respectively, correspondingly to the angles of view.

In the self-luminous panel 65, pixels allocated to RGB can be used as the same color in each of the B display region and the R display region, and the resolution can be increased by, for example, three times in these monochromatic regions. Note that, in the self-luminous panel 65, different panels may be arranged adjacent to each other correspondingly to the angles of view, or separation of pixels by in the same panel may be changed.

Next, with reference to FIGS. 12 to 14, cases where a transmission-type panel or a reflective panel that is not a self-luminous panel is used will be described. FIG. 12 is a schematic view illustrating examples of a transmissive color filter to be inserted into the image display device according to the present embodiment. FIG. 12A illustrates an example in which a color filter is inserted into the lower surface of the panel, and FIG. 12B illustrates an example in which a color filter is inserted into the upper surface of the panel.

As illustrated in FIG. 12A, in the color filter 70, a blue color filter 72 is inserted into a B display region and a red color filter 73 is inserted into an R display region on the lower surface of the transmissive panel 71 on which white illumination light WL is incident. Furthermore, as illustrated in FIG. 12B, in a color filter 75, a blue color filter 72 is inserted into a B display region and a red color filter 73 is inserted into a R display region on the upper surface of a transmissive panel 71 on which white illumination light WL is incident.

FIG. 13 is a diagram illustrating an example of removing background noise by adding a color filter to the image display device according to the present embodiment. FIG. 13A illustrates a state before the color filter is inserted, and FIG. 13B illustrates a state after the color filter is inserted.

In a case where a transmissive panel or a reflective panel that is not a self-luminous panel is used, it is known that background noise occurs in a B display region and an R display region as illustrated in FIG. 13A. Therefore, in the image display device according to the present embodiment, like the color filter 70 or the color filter 75, the blue color filter 72 and the red color filter 73 are inserted into the corresponding angle-of-view regions. As a result, as illustrated in FIG. 13B, background noise in the B display region and the R display region can be removed. Furthermore, by using the color filter, it is also possible to improve the angle-of-view display stability and the contrast.

FIG. 14 is a graph illustrating variations in average wavelength in a case where the image display device according to the present embodiment includes a band-pass filter. FIG. 14A illustrates variation in average wavelength in a case where there is no band-pass filter, and FIG. 14B illustrates variation in average wavelength in a case where there is a band-pass filter. Furthermore, in each of the graphs of FIGS. 14A and 14B, the horizontal axis represents the wavelength, and the vertical axis represents output of the light source.

As illustrated in FIG. 14A, in a case where there is no band-pass filter, the average wavelength of the light source spectrum varies in some cases depending on temperature, current, the rod, or the like. Therefore, the image display device according to the present embodiment can include a band-pass filter. As a result, as illustrated in FIG. 14B, variation in the wavelength of the light source spectrum can be suppressed. As a result, the image display device according to the present embodiment can suppress the deviation of the angle of view caused by a change in wavelength due to the temperature characteristic of the light source or the like.

### 5. Fifth Embodiment

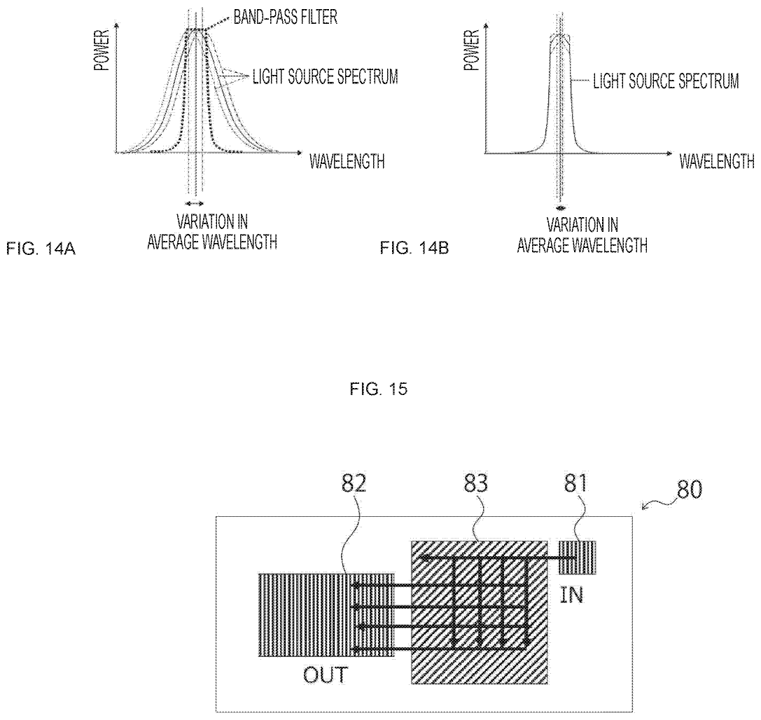

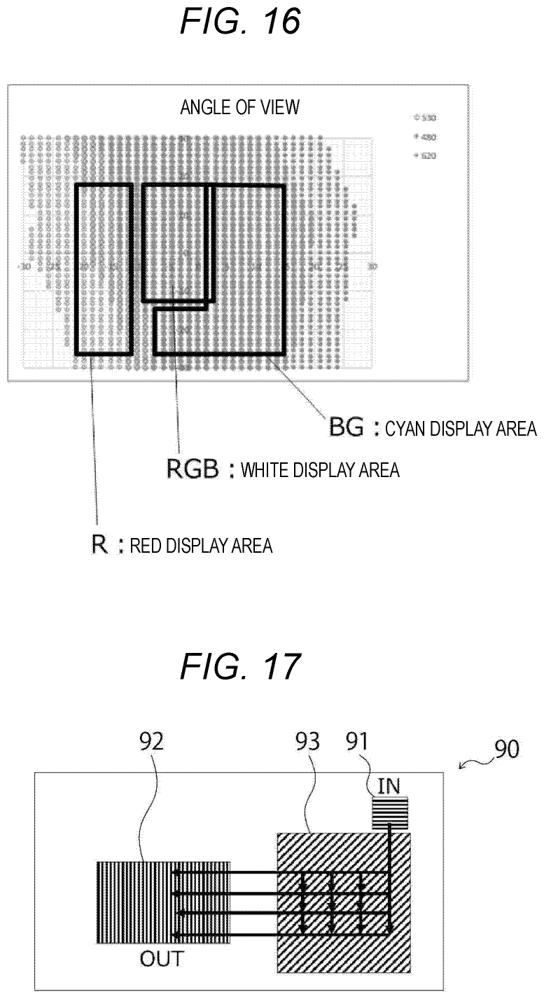

Next, a configuration example of diffraction gratings of an image display device according to a fifth embodiment of the present technology will be described with reference to FIGS. 15 and 16. FIG. 15 is a schematic view illustrating an installation example of the diffraction gratings in the image display device according to the present embodiment. FIG. 16 is a schematic view illustrating an example of display divided by color by uniaxial expansion arrangement, displayed by using the image display device according to the present embodiment.

As illustrated in FIG. 15, an image display device 80 according to the present embodiment includes an incident-side diffraction grating 81, an emission-side diffraction grating 82, and a third diffraction grating 83 as a uniaxial expansion between the incident-side diffraction grating 81 and the emission-side diffraction grating 82.

The third diffraction grating 83 is a diffraction grating for widening an angle of view of an axis in a direction orthogonal to the light guide direction. In the image display device 80, the grating vectors of the incident-side diffraction grating 81 and the emission-side diffraction grating 82 are in a relationship of being closed to each other, and the third diffraction grating 83 has only the function of enlarging the pupil of a light beam in the direction orthogonal to the light guide direction. Thus, the angle of the light beam is folded back when light is guided, but returned to the original angle when used.

As an example, a material having a material refractive index of 1.6 is used for the third diffraction grating 83. Furthermore, the inclination of the pitch of the incident-side diffraction grating 81 and the emission-side diffraction grating 82 is set to 0 degrees when viewed from a wide surface of the light guide plate, and the third diffraction grating 83 is arranged to be inclined at about 68 degrees. In this case, as illustrated in FIG. 16, color region arrangement of an R display region, a white display region, and a cyan (BG) display region is formed according to the angle of view from the relationship with the angle-of-view range that can be set for each color.

### 6. Sixth Embodiment

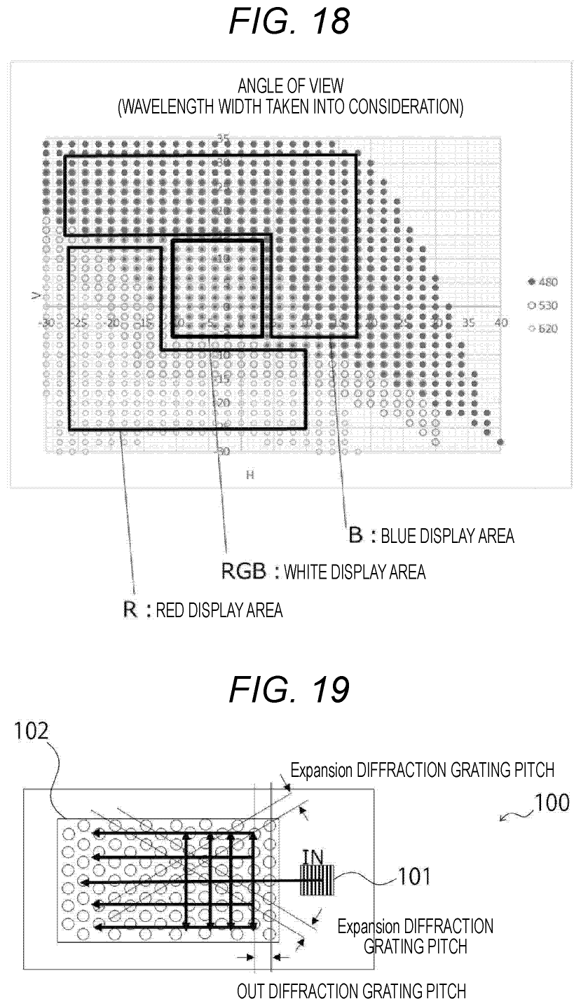

Next, a configuration example of diffraction gratings of an image display device according to a sixth embodiment of the present technology will be described with reference to FIGS. 17 and 18. FIG. 17 is a schematic view illustrating an installation example of diffraction gratings in the image display device according to the present embodiment. FIG. 18 is a schematic view illustrating an example of display divided by color by biaxial arrangement, displayed by using the image display device according to the present embodiment.

As illustrated in FIG. 17, an image display device 90 according to the present exemplary embodiment includes an incident-side diffraction grating 91, an emission-side diffraction grating 92, and a third diffraction grating 93 biaxially arranged between the incident-side diffraction grating 91 and the emission-side diffraction grating 92.

The third diffraction grating 93 is arranged as a diffraction grating for bending an optical path of a light beam. The image display device 90 is characterized in that two grating vectors are closed by the incident-side diffraction grating 91, the third diffraction grating 93, and the emission-side diffraction grating 92, and the light-beam angle at the time of incidence on a light guide plate is stored when the light beam is emitted. The image display device according to the present embodiment can widen the displayable angle of view by arranging the third diffraction grating 93.

In the case of using the image display device 90, as illustrated in FIG. 18, color region arrangement of a white display region in a rectangular shape at the center, an R display region in two axial directions of a high wavelength region so as to surround the white display region, and a B display region in two axial directions of a low wavelength region so as to surround the white display region is formed.

### 7. Seventh Embodiment

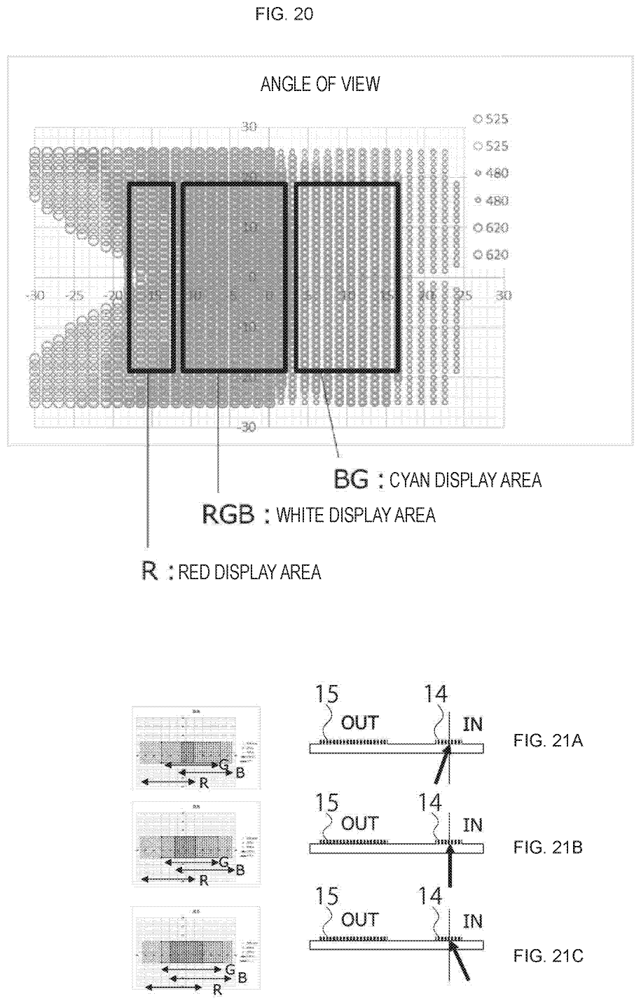

Next, a configuration example of diffraction gratings of an image display device according to a seventh embodiment of the present technology will be described with reference to FIGS. 19 and 20. FIG. 19 is a schematic view illustrating an installation example of diffraction gratings in the image display device according to the present embodiment. FIG. 20 is a schematic view illustrating an example of display divided by color by protruding shape arrangement, displayed by using the image display device according to the present embodiment. As an example, the protruding shape is a shape in which a front end on a cylindrical shape is pointed.

As illustrated in FIG. 19, an image display device 100 according to the present embodiment includes an incident-side diffraction grating 101 and a third diffraction grating 102 as a uniaxial expansion in which an emission-side diffraction grating and expansion of a display angle-of-view (expansion of a pupil) in a direction orthogonal to the light guide direction are integrated. The third diffraction grating 102 also serves as an emission-side diffraction grating. The third diffraction grating 102 has a function of enlarging the display angle-of-view (enlarging the pupil) of image light in the direction orthogonal to the light guide direction. In the third diffraction grating 102, the grating has a hexagonal close-packed structure or a structure close thereto.

The image display device 100 has an emission-side diffraction grating pitch in a direction from the incident-side diffraction grating 101 toward the third diffraction grating 102, that is, in a direction orthogonal to the light guide direction, at a location where the third diffraction grating 102 is arranged. Furthermore, the image display device 100 has an expansion diffraction grating pitch in two directions obliquely intersecting with the orthogonal direction described above at the location where the third diffraction grating 102 is arranged. According to the present embodiment, the entire layout area (size of the light guide plate) can be made smaller than that in biaxial or uniaxial expansion arrangement. Furthermore, according to the present embodiment, the display angle-of-view can be widened in a direction orthogonal to the vector directions of the two diffraction gratings, that is, the incident-side diffraction grating 101 and the third diffraction grating 102.

In the case of using the image display device 100, as illustrated in FIG. 20, color region arrangement of an R display region in a high wavelength region, a BG display region in two axial directions of a low wavelength region, and a white display region in a central region between the R display region and the BG display region is formed correspondingly to the angles of view.

### 8. Eighth Embodiment

Next, a relationship between a diffraction grating and an incident angle of image light in an image display device according to an eighth embodiment of the present technology will be described with reference to FIG. 21. FIG. 21 is a schematic view illustrating a relationship between an incident angle and selectable colors by the image display device according to the present embodiment.

FIG. 21A illustrates a case where image light is vertically incident on an incident-side diffraction grating 14 by inclining the position of a light source in a direction approaching an emission-side diffraction grating 15. FIG. 21B illustrates a case where image light is vertically incident on the incident-side diffraction grating 14. FIG. 21C illustrates a case where image light is vertically incident on the incident-side diffraction grating 14 by inclining the position of the light source in a direction away from the emission-side diffraction grating 15.

As illustrated in FIG. 21C, by inclining the incident angle of image light on the incident-side diffraction grating 14 in the direction away from the emission-side diffraction grating 15, an RGB white display region can be enlarged as compared with cases where the image light is incident as illustrated in FIGS. 21A and 21B. As a result, the image display device according to the present embodiment illustrated in FIG. 21C can increase the display region of the white display region. As a result, the image display device according to the present embodiment illustrated in FIG. 21C can increase the degree of freedom in division of display by color.

Therefore, for example, in the case of arrangement in one axial direction as in the diffraction gratings of the fifth embodiment illustrated in FIG. 15, the white display region is widened by inclining the incident angle of the image light in a direction away from the emission-side diffraction grating with respect to the axis of the light guide direction. Furthermore, in a case of arrangement in two axial directions as in the diffraction gratings of the sixth embodiment illustrated in FIG. 17, since the incident-side diffraction grating and the emission-side diffraction grating are in a diagonal direction in a light guide plate surface, the white display region is widened by inclining the incident angle of image light in a direction away from the emission-side diffraction grating in the diagonal direction.

Moreover, the image display device according to the present embodiment illustrated in FIG. 21C is an effective configuration also in a case where entirety is displayed in white. Note that the image display device according to the present embodiment can also bring an image or a video to the left or right of the screen.

### 9. Ninth Embodiment

Next, an arrangement example of image display devices according to a ninth embodiment of the present technology will be described with reference to FIG. 22. FIG. 22A is a schematic view illustrating an arrangement example of the image display devices according to the present embodiment. FIG. 22B is a schematic view illustrating an example of display of a display image divided by color by the image display devices according to the present embodiment. The present embodiment illustrates an arrangement example in which the image display devices are applied to both eyes and a white display region is increased in binocular vision.

As illustrated in FIG. 22A, in the present embodiment, as an example, the image display device 10 according to the first embodiment is applied to an eyeball 16 of the right eye of the user, and an image display device 110 having an arrangement configuration contrast to that of the image display device 10 is applied to an eyeball 116 of the left eye of the user.

The image display device 110 includes a light guide plate 111, a projection lens 112, and an image forming unit 113 at positions line-symmetric with respect to a center position between both the eyes 16 and 116 of the user.

The light guide plate 11 of the image display device 10 and the light guide plate 111 of the image display device 110 are arranged to be inclined at an angle θ in directions in which the upper surfaces thereof face each other with respect to the line-of-sight direction of both the eyes 16 and 116.

The projection lens 12 and the image forming unit 13 of the image display device 10 are arranged to be inclined at an angle θ in a direction away from the emission-side diffraction grating 15 with respect to a direction vertical to the surface of the light guide plate 11. Similarly, the projection lens 112 and the image forming unit 113 of the image display device 110 are arranged to be inclined at the angle θ in a direction away from an emission-side diffraction grating with respect to the direction vertical to the surface of the light guide plate 111. Note that due to arrangement of the present embodiment, the incident angle of image light with respect to the light guide plates 11 and 111 is inclined at the angle θ. The inclination angle θ is preferably in a range of θ>0 in a case where the refractive index of an incident-side diffraction grating is low, but may be θ=0 in a case where the refractive index of the incident-side diffraction grating is high. Here, the direction away from the emission-side diffraction grating includes not only the case of the left-right direction (X-axis direction) of FIG. 22 as one faces but also the case of the front-back direction (Y-axis direction) of FIG. 22 as one faces. Moreover, when a third diffraction grating is also arranged, the direction away from the emission-side diffraction grating also includes the case of both the X-axis direction and the Y-axis direction described above.

As illustrated in FIGS. 22A and 22B, by arranging the image display device 10 and the image display device 110 according to the present embodiment, the central angle-of-view can be clearly seen by binocular vision. Therefore, the white display region can be enlarged, and the display region can be further widened. Note that the angle of view at the end of the display screen is displayed in white by adding colors together at the user's left and right eyes, whereby the white display region can be increased in a pseudo manner.

### 10. Tenth Embodiment

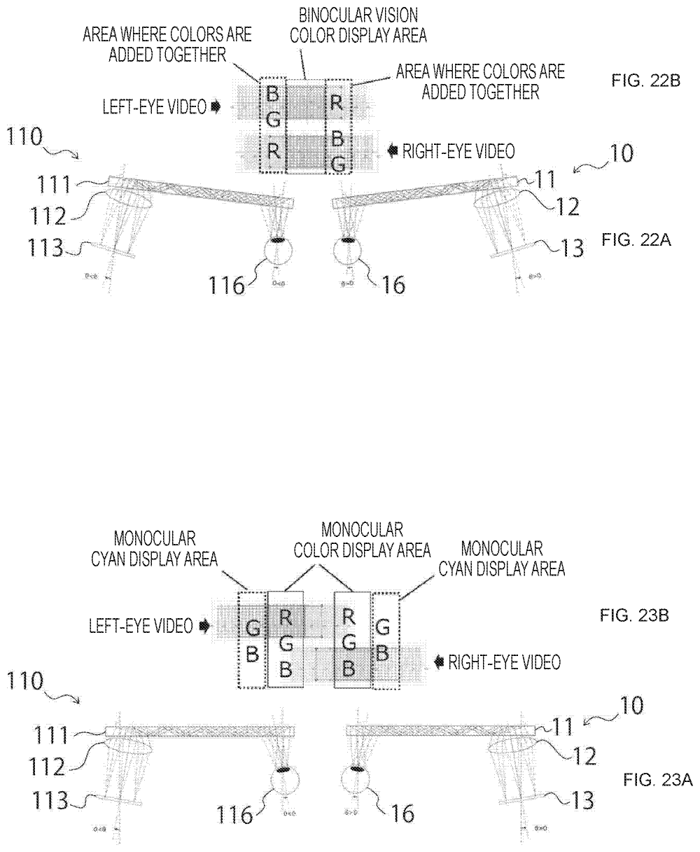

Next, an arrangement example of image display devices according to a tenth embodiment of the present technology will be described with reference to FIG. 23. FIG. 23A is a schematic view illustrating an arrangement example of the image display devices according to the present embodiment. FIG. 23B is a schematic view illustrating an example of display of a display image divided by color by the image display devices according to the present embodiment. In the present embodiment, an arrangement example is illustrated in which the image display devices are applied to both eyes and the display region is enlarged by performing display in each monocular vision.

As illustrated in FIG. 23A, in the present embodiment, similarly to the ninth embodiment, the image display device 10 is applied to the eyeball 16 of the right eye of the user, and the image display device 110 is applied to the eyeball 116 of the left eye of the user. The present embodiment is different from the ninth embodiment in that light guide plates 11 and 111 are arranged on the same plane, and the other configurations are similar to those of the ninth embodiment.

As illustrated in FIGS. 23A and 23B, by arranging the image display device 10 and the image display device 110 according to the present embodiment, it is possible to display information different in the left and right eyes without providing a binocular vision area. As a result, an observable angle-of-view range can be increased. The image display devices according to the present embodiment can perform, for example, work support display such as checking a work manual with one eye and performing actual work with the other eye, for example.

### 11. Eleventh Embodiment

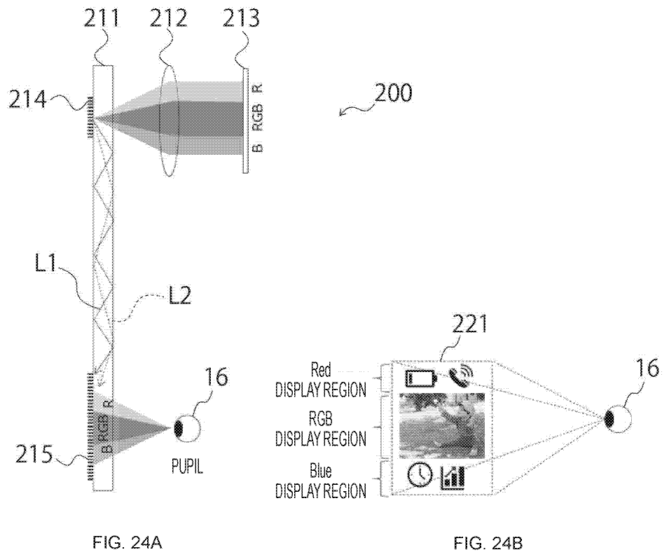

Next, an arrangement example of an image display device according to an eleventh embodiment of the present technology will be described with reference to FIG. 24. FIG. 24A is a schematic view illustrating an arrangement example of the image display device according to the present embodiment. FIG. 24B is a schematic view of an example of a display image displayed by using the image display device according to the present embodiment. In the present embodiment, an arrangement example of an image display device 200 obtained by moving the arrangement of the image display device 10 according to the first embodiment by 90 degrees is illustrated.

As illustrated in FIG. 24A, the image display device 200 includes, as an example, a light guide plate 211, a projection lens 212, an image forming unit 213 having light-emitting light sources with two or more wavelengths, an incident-side diffraction grating 214, and an emission-side diffraction grating 215. In the image display device 200, the light guide direction of image light incident on the light guide plate 211 is set to the vertical direction.

As illustrated in FIG. 24B, in the display image displayed by image display device 200, as an example, an R display region is formed at an upper end, a B display region is formed at a lower end, and an RBG display region is formed at the center of the R display region and the B display region.

Similarly to the image display device 10 according to the first embodiment, the image display device 200 according to the present embodiment can display more information by enlarging a display angle-of-view region while suppressing color unevenness with a simple configuration. Note that the image display device according to the present technology can arbitrarily change the display region depending on whether light is guided in the horizontal direction or in the vertical direction. Furthermore, the image display device according to the present technology can enlarge the angle of view of the display image similarly by any arrangement system such as uniaxial expansion arrangement, biaxial arrangement, protruding shape arrangement or the like. According to the present embodiment, an image can be displayed in white and characters can be displayed below. As a result, the present embodiment can be positively used in a case where the characters do not need to be displayed in white.

Note that the present technology can be configured as follows.
(1)
   An image display device including:
   an image forming unit that has a plurality of pixels and emits image light from the plurality of pixels;
   an optical system that converts each beam of the image light having an image height emitted from the image forming unit into a parallel beam having an angle of view;
   a light guide plate on which the image light converted by the optical system is incident, in which the image light propagates, and from which the image light is emitted to the outside;
   a first diffraction grating that is provided on the light guide plate, diffracts and reflects the image light incident on the light guide plate, and propagates the image light inside the light guide plate; and
   a second diffraction grating that is provided on the light guide plate, diffracts and reflects the image light that has propagated inside the light guide plate, and emits the image light from the light guide plate to the outside,
   in which the image forming unit divides the image light into a plurality of color beams.
(2)
   The image display device according to (1), in which the image forming unit includes a color filter.
(3)
   The image display device according to (1) or (2), in which the image forming unit is arranged at a position where an incident angle formed by the image light emitted and a normal line of a surface of the light guide plate on which the image light is incident is inclined in a direction away from the second diffraction grating.
(4)
   The image display device according to any one of (1) to (3), in which each of the first diffraction grating and the second diffraction grating is a surface-relief type or volume type hologram.
(5)
   The image display device according to (4), in which the surface-relief type hologram has a blazed shape including an overhang or a stepped shape.
(6)
   The image display device according to any one of (1) to (5), in which in the light guide plate, a third diffraction grating is arranged at a location where grating vectors of the first diffraction grating and the second diffraction grating intersect each other.
(7)
   The image display device according to (6), in which a grating vector of the third diffraction grating intersects the grating vectors of the first diffraction grating and the second diffraction grating.
(8)
   The image display device according to any one of (1) to (7), in which the second diffraction grating is arranged in a protruding shape with respect to a surface of the light guide plate.
(9)
   The image display device according to any one of (1) to (8) including:
   the two image forming units for a right eye and a left eye; the two light guide plates for the right eye and the left eye; the two first diffraction gratings for the right eye and the left eye; and the two second diffraction grating for the right eye and the left eye,
   in which an image is displayed by superimposing an image for the right eye and an image for the left eye.
(10)
   The image display device according to (9), in which a binocular vision region and a monocular vision region are displayed.
(11)
   The image display device according to (10), in which the binocular vision region displays a color region, and the monocular vision region displays a white region.
(12)
   The image display device according to (9), in which a binocular vision region is not displayed.
(13)
   An image display method including:
   a step of including a plurality of pixels and emitting image light divided into a plurality of color beams from the plurality of pixels;
   a step of causing the image light that has been emitted to be incident on a light guide plate;
   a step of diffracting and reflecting the image light incident on the light guide plate and propagating the image light inside the light guide plate; and
   a step of diffracting and reflecting the image light that has propagated inside the light guide plate and emitting the image light from the light guide plate to the outside.

### REFERENCE SIGNS LIST

10, 40, 42, 44, 80, 90, 110, 200 Image display device
11, 111, 211 Light guide plate
12, 112, 212 Projection lens (Optical system)
13, 113, 213 Image forming unit
14, 31, 34, 37, 41, 81, 91, 214 Incident-side diffraction grating (First diffraction grating)
15, 43, 51, 54, 82, 92, 215 Emission-side diffraction grating (Second diffraction grating)
16, 116 Eyeball
21, 221 Display image
32, 35, 38, 52, 55 Diffraction grating
33, 36, 39 Highly reflective metal film
53, 56 High refractive material film
60 to 63, 65 to 68, 71 Panel
70, 75 Color filter
72 Blue color filter
73 Red color filter
83, 93, 102 Third diffraction grating
L1, L2 Incident beam
WL White illumination light

1. An image display device comprising:
an image forming unit that has a plurality of pixels and emits image light from the plurality of pixels;
an optical system that converts each beam of the image light having an image height emitted from the image forming unit into a parallel beam having an angle of view;
a light guide plate on which the image light converted by the optical system is incident, in which the image light propagates, and from which the image light is emitted to the outside;
a first diffraction grating that is provided on the light guide plate, diffracts and reflects the image light incident on the light guide plate, and propagates the image light inside the light guide plate; and
a second diffraction grating that is provided on the light guide plate, diffracts and reflects the image light that has propagated inside the light guide plate, and emits the image light from the light guide plate to the outside,
wherein the image forming unit divides the image light into a plurality of color beams.

2. The image display device according to claim 1, wherein the image forming unit includes a color filter.

3. The image display device according to claim 1, wherein the image forming unit is arranged at a position where an incident angle formed by the image light emitted and a normal line of a surface of the light guide plate on which the image light is incident is inclined in a direction away from the second diffraction grating.

4. The image display device according to claim 1, wherein each of the first diffraction grating and the second diffraction grating is a surface-relief type or volume type hologram.

5. The image display device according to claim 4, wherein the surface-relief type hologram has a blazed shape including an overhang or a stepped shape.

6. The image display device according to claim 1, wherein in the light guide plate, a third diffraction grating is arranged at a location where grating vectors of the first diffraction grating and the second diffraction grating intersect each other.

7. The image display device according to claim 6, wherein a grating vector of the third diffraction grating intersects the grating vectors of the first diffraction grating and the second diffraction grating.

8. The image display device according to claim 1, wherein the second diffraction grating is arranged in a protruding shape with respect to a surface of the light guide plate.

9. The image display device according to claim 1 comprising:
the two image forming units for a right eye and a left eye; the two light guide plates for the right eye and the left eye; the two first diffraction gratings for the right eye and the left eye; and the two second diffraction grating for the right eye and the left eye,
wherein an image is displayed by superimposing an image for the right eye and an image for the left eye.

10. The image display device according to claim 9, wherein a binocular vision region and a monocular vision region are displayed.

11. The image display device according to claim 10, wherein the binocular vision region displays a color region, and the monocular vision region displays a white region.

12. The image display device according to claim 9, wherein a binocular vision region is not displayed.

13. An image display method comprising:
a step of including a plurality of pixels and emitting image light divided into a plurality of color beams from the plurality of pixels;
a step of causing the image light that has been emitted to be incident on a light guide plate;
a step of diffracting and reflecting the image light incident on the light guide plate and propagating the image light inside the light guide plate; and
a step of diffracting and reflecting the image light that has propagated inside the light guide plate and emitting the image light from the light guide plate to the outside.
